(19) United States
(12) Patent Application Publication
(10) Pub. No.: US 2025/0189931 A1
(43) Pub. Date: Jun. 12, 2025

(54) ASSEMBLY OF TWO TIMEPIECE COMPONENTS WITH IMPROVED ASSEMBLY MEANS

(71) Applicant: ETA SA Manufacture Horlogère Suisse, Grenchen (CH)

(72) Inventors: Julien CHRISTAN, Bienne (CH); Mohammad Hussein KAHROBAIYAN, Boudevilliers (CH); Romain LE MOAL, Villers-le-Lac (FR); Pascal WINKLER, St-Blaise (CH)

(73) Assignee: ETA SA Manufacture Horlogère Suisse, Grenchen (CH)

(21) Appl. No.: 18/947,472

(22) Filed: Nov. 14, 2024

(30) Foreign Application Priority Data
Dec. 11, 2023 (EP) 23215614.1

(51) Int. Cl. G04B 15/14

(52) U.S. Cl. CPC G04B 15/14

(57) ABSTRACT

An assembly of a horological movement, which assembly includes a first timepiece component (22), for example a plate extending in a first plane, and a second timepiece component (30), for example an actuator of an actuation system, the assembly (1) including means (40) for assembling the first timepiece component (22) to the second timepiece component (30), wherein the assembly means (40) comprise means (50) for positioning the second component (30) on the first component (22) in a plane substantially parallel to the first component (22), and means (60) for bearing on the second component (30) to lock the second component (30) on the first component (22).

### CROSS-REFERENCE TO RELATED APPLICATIONS

This application claims priority to European Patent Application No. 23215614.1 filed on Dec. 11, 2023, the entire contents of which are incorporated herein by reference.

### TECHNICAL FIELD OF THE INVENTION

The invention relates to the field of watchmaking, and more particularly to the field of mechanical watchmaking.

The invention relates more specifically to an assembly of two timepiece components for a horological movement.

### TECHNOLOGICAL BACKGROUND

In most mechanical watches, the components are assembled together on a plate by known conventional means, such as driving, screwing, casing or, more rarely, adhesive bonding or brazing.

The components are typically mounted in the movement in a stack of successive planes substantially parallel to the plate. The components are, for example, gear wheels, cocks, etc.

Some components have to be mounted perpendicular to the plane of the plate, in particular the rotary arbors and staffs, for example for the gear wheels or for the balance. However, since the rotary arbors and staffs are small in volume, they are easy to assemble.

However, some of the larger components are more complex to assemble in the movement, particularly if they have to be assembled orthogonally to the plate.

Moreover, they may be required to interact with other components of the movement, for example by interlocking or meshing therewith, making them difficult to assemble.

Another problem linked to the assembly of timepiece components is the possible presence of play between the two components once they have been assembled.

### SUMMARY OF THE INVENTION

The aim of the present invention is to overcome some or all of the aforementioned drawbacks by proposing means for assembling a timepiece component in a horological movement, which assembly avoids the aforementioned problems.

To this end, the invention relates to an assembly of two timepiece components for a horological movement, the assembly comprising a first timepiece component, for example a plate extending in a first plane, and a second timepiece component, for example an actuator of an actuation system, the assembly comprising means for assembling the first timepiece component to the second timepiece component.

The invention is characterised in that the assembly means comprise means for positioning the second component on the first component in a plane substantially parallel to the first component, and means for bearing on the second component to lock the second component on the first component in a direction substantially orthogonal to the first component.

Thanks to the invention, an efficient and simplified assembly of the two timepiece components is obtained, as the second component is simply positioned on the first component and held laterally by the positioning means, then bearing means are arranged on the second component to lock it in position and assemble it on the first component.

These assembly means are simple to implement and are effective, because the positioning means place the second component in a plane substantially parallel to the plane of the first component, and the bearing means hold the second component in a second direction perpendicular to the previous plane.

Moreover, such an assembly makes it easy to assemble a timepiece component perpendicularly to the plate.

In a particular embodiment of the invention, the second component extends in a plane substantially perpendicular to the first component.

According to a particular embodiment of the invention, the positioning means comprise at least one first catch, preferably two catches, arranged on the second component, and at least one hole, preferably two holes, arranged in the first component, so that each catch is inserted into a hole to assemble the two components.

According to a particular embodiment of the invention, at least one catch can be snapped into a hole.

According to a particular embodiment of the invention, the bearing means comprise an assembly body arranged on the first component, and the second component comprises a bearing face, on which the assembly body bears to lock the second component in position.

According to a particular embodiment of the invention, the assembly body comprises a rigid tab for bearing on the first component.

According to a particular embodiment of the invention, the second component has an opening through which the rigid tab can pass.

According to a particular embodiment of the invention, the assembly means comprise a screw and the assembly body comprises a passage for assembling the assembly body to the first component, the first component being provided with an internally threaded hole for the screw.

According to a particular embodiment of the invention, the second component comprises a stationary part intended to be mounted on the first component, and a movable part that is capable of moving relative to the first component.

According to a particular embodiment of the invention, the stationary part comprises the one or more catches.

According to a particular embodiment of the invention, the opening is arranged between the stationary part and the movable part.

According to a particular embodiment of the invention, the assembly body bears on the stationary part.

The invention further relates to a horological movement comprising such a horological assembly.

The invention further relates to a timepiece, for example a watch, comprising such a horological movement.

### BRIEF DESCRIPTION OF THE FIGURES

The aims, advantages and features of the present invention will become apparent from the detailed description of several embodiments given solely by way of non-limiting examples, with reference to the accompanying drawings in which:

FIG. 1 diagrammatically shows a perspective view of part of a horological movement comprising a regulating member and an assembly of a first and of a second component, according to one embodiment of the invention,

FIG. 2 diagrammatically shows a top view of one embodiment of a balance spring of the regulating member,

FIG. 3 diagrammatically shows a side view of the second timepiece component of the assembly, in this case an actuator of the system for actuating the regulating member in FIG. 1,

FIG. 4 diagrammatically shows a perspective, exploded view of the assembly, and

FIG. 5 diagrammatically shows a top view of the assembly in the assembled position.

### DETAILED DESCRIPTION OF THE INVENTION

In the following description, the subject matter of the invention, which is a horological assembly, is provided with means for assembling two timepiece components, the first component of which is the plate of a horological movement, and the second component of which is an actuator of means for adjusting a regulating member. However, such an assembly could relate to other components of a horological movement, and it is by no means limited to these components or to other components of a regulating member.

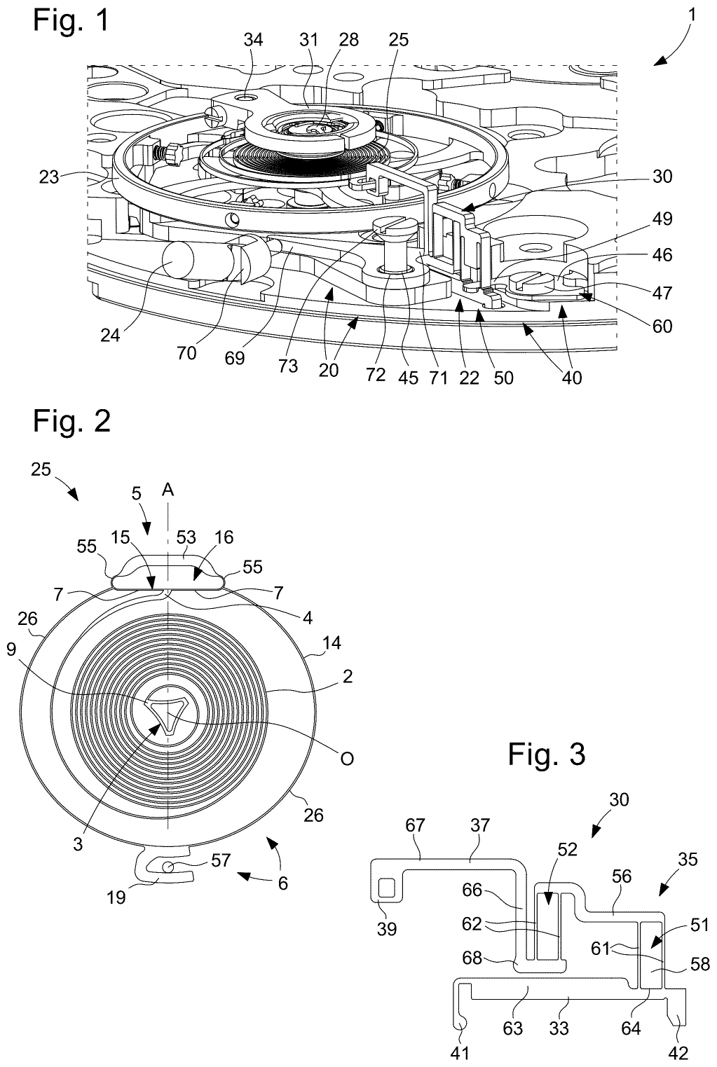

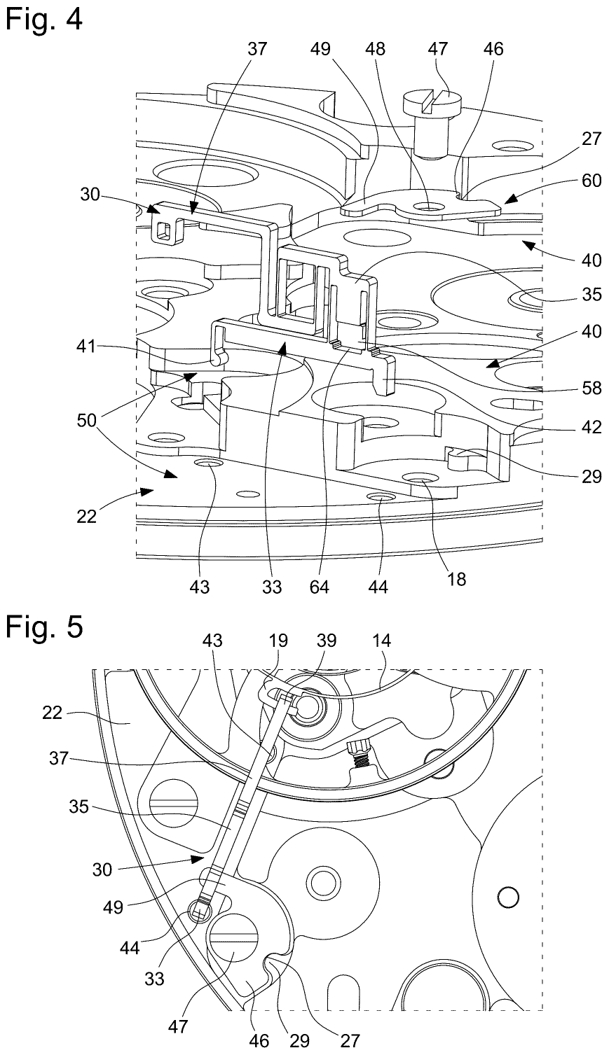

FIG. 1 diagrammatically shows one embodiment of part of a horological movement comprising a plate provided with a recess and a regulating member 1. Such a movement is, for example, arranged in a timepiece, such as a watch.

The regulating member 1 comprises an inertial mass, in this case an annular balance 23, a balance spring 25 as a resilient return element for the inertial mass configured to cause it to oscillate, a balance staff, and a balance cock, not shown in the figure. The elements are stacked from bottom to top in the following order: the first timepiece component 22, the balance 23, and the balance spring 25.

The balance staff passes through the centre of the balance and of the balance spring 25. The balance staff is held by two shock-resistant bearings 28 arranged at both ends of the balance staff. A first bearing is arranged below the balance cock, in the plate 22, and the second bearing 28 is arranged therein. The balance cock has a through-hole inside which the second bearing 28 is held.

As shown in FIG. 2, the balance spring 25 preferably extends substantially in one plane. The balance spring 25 comprises a flexible strip 2 wound about itself in several turns, the strip 2 having a predefined stiffness. The inside end 9 of the strip 2 is integral with or assembled with a rigid support 3, typically referred to as a collet. The rigid support 3 is substantially triangular in shape and is threaded around the balance staff.

The balance spring 25 further includes means for adjusting its stiffness. For example, the adjustment means can in particular be actuated by a user when the regulating member is mounted in the horological movement.

The adjustment means comprise a flexible element 5 arranged in series with the strip 2, i.e. following on from the strip, preferably as an extension thereof, the flexible element 5 connecting an outside end 4 of said strip 2 to a rigid support 53. The flexible element 5 is integral with the outside end 4 of the strip 2. The flexible element 5 is a different element from the strip 2.

The flexible element 5 adds additional stiffness to that of the strip 2. The flexible element 5 is preferably stiffer than the strip 2. In this case, the flexible element 5 is arranged as an extension of the strip 2. Preferably, the adjustment means and the strip 2 are in one piece, or even made of the same material, for example silicon.

In this embodiment of the balance spring, the flexible element 5 comprises two flexible parts 15, 16, each connecting the strip 2 to a fixed support 53.

The two flexible parts 15, 16 are arranged, relative to one another, in axial symmetry along an axis A of the balance spring 25. In other words, the two flexible parts 15, 16 are positioned so as to be symmetrical relative to said axis A.

On the one hand, the axis A passes substantially through the centre O of the balance spring, and on the other hand, the axis A preferably passes through the outside end 4 of the strip 2.

Thus, the two flexible parts 15, 16 are arranged on the periphery of the balance spring, such that the two flexible parts 15, 16 are arranged at the same distance from the centre O of the balance spring 25.

The two flexible parts 15, 16 are preferably arranged relative to one another in a “mirror-like” position relative to the axis A. To this end, the two flexible parts 15, 16 are preferably substantially identical.

The flexible parts 15, 16 each comprise a curved flexible blade 55, preferably forming a semi-circle, and extending from the end of the fixed support 53. Each curved flexible blade 55 is also connected to the outside end 4 of the strip 2 by a flexible blade 7.

The fixed support 53 has the shape of a trapezium closed by a flexible blade 7.

The means for adjusting the balance spring 25 further include prestressing means 6 for applying a variable force or torque to the flexible element 5. In this way, the stiffness of the balance spring can be adjusted. The torque or force is continuously adjustable thanks to the prestressing means 6. In other words, the torque or force is not restricted to point values. The stiffness of the flexible element 5 can thus be adjusted with great precision.

Preferably, the prestressing means 6 apply a substantially identical force or torque to each flexible part 15, 16. The directions of the forces are preferably substantially symmetrical.

The prestressing means 6 further comprise two levers 14, 26, each connecting a curved blade 55 to the same movable body 19 arranged on the other side of the balance spring 25 relative to the fixed support 53.

The movable body 19 is, for example, U-shaped, allowing it to engage with an actuator that is, for example, provided with a hook or a finger inserted into the U shape, as it is arranged tangentially to the levers 14, 26.

The variable force or torque is applied to the movable body 19. The variable force or torque is at least partly transmitted to the curved blades 55 of the flexible parts 15, 16 of the flexible element 5, via the levers 14, 26.

In order to be able to apply the variable force or torque to the balance spring 25, the regulating member comprises a specific actuation system 20.

In this embodiment, the regulating member 1 comprises a stud-holder 31 provided with a suspended stud 34. The stud-holder 31 is mechanically connected to the flexible element 5, but does not block the strip 2. The stud-holder 31 surrounds the second bearing 28. For this purpose, the stud-holder 31 comprises a central ring arranged around the second bearing 28, and which rests on the balance cock (not shown).

The stud 34 cooperates with the rigid support 55. In this way, the prestressing means 6 and the flexible element 5 are supported by the stud-holder 31 from which they are suspended.

Moreover, the stud 34 is rigidly attached to the rigid support 55. In other words, the stud 34 is integral with the rigid support 55. The stud 34 and the balance spring 25 are assembled, for example, by bonding, brazing, welding, by deformation of metallic glass, or by mechanical fastening.

The stud 34 is movable relative to the first timepiece component 22. To this end, the stud-holder 31 can rotate about the second bearing 28 relative to the first timepiece component 22. The stud-holder 31 can, for example, be displaced over an angular range of 20° or even 10°.

By displacing the stud 34 relative to the first timepiece component 22, the beat of the regulating member 1 can be regulated.

The actuation system 20 further comprises a second timepiece component 30, which is an actuator configured to actuate the movable body 19. The second timepiece component 30 is mechanically connected to the prestressing means 6, the second timepiece component 30 being configured to perform at least in part a substantially linear, preferably rectilinear, displacement in a plane substantially perpendicular to the plate, in order to actuate the prestressing means 6.

In other words, at least part of the second timepiece component 30 moves substantially along a straight line, unlike, for example, the stud-holder 31 which undergoes rotation by turning about an axis, in a plane substantially parallel to the plate. In this way, at least part of the second timepiece component 30 moves towards or away from the balance spring 25 in a direction oriented substantially towards the balance spring.

Preferably, the direction of displacement of the second timepiece component 30 is substantially radial with respect to the balance 23 and the balance spring 25. In this way, the straight line along which the second timepiece component 30 moves, is directed towards the centre of the balance 23 and the balance spring 25. This also makes the rate setting independent of the beat setting. More specifically, by displacing the stud 34 relative to the first timepiece component 22, the beat of the regulating member 1 can be regulated.

The second timepiece component 30 is off-centred with respect to the regulating member, i.e. it is mounted at a distance from the centre of the regulating member 1, and is connected only to the movable body 19 of the adjustment means. The second timepiece component 30 is therefore not mounted directly on the regulating member 1, like a stud-holder on a bearing 28 of the regulating member 1, for example.

Thus, the horological movement comprises an assembly 10 comprising the first timepiece component 22, in this case the plate, and the second timepiece component 30, in this case an actuator of the adjustment means.

In this embodiment, the first timepiece component 22 is the plate of the horological movement, and the second timepiece component 30 is an actuator. The second timepiece component 30 is mounted on the first timepiece component 22. The second timepiece component 30 is mounted perpendicularly to the first timepiece component 22.

In FIG. 3, the second timepiece component 30 comprises in particular a stationary part 33 mounted on the first timepiece component 22, a part 37 movable relative to the first timepiece component 22 and connected to the levers 14, 26, and a spring part 35, formed by a flexure bearing, joining the movable part 37 to the stationary part 33. The stationary part 33 and the movable part 37 are preferably rigid. The stationary part 33, the spring part 35 and the movable part 37 are preferably arranged in the same plane. The second timepiece component 30 is therefore generally flat and extends substantially in one plane.

To actuate the movable body 19, the second timepiece component 30 comprises a hook 39 engaged with the U of the movable body 19. The hook 39 is closed, but could also be partially open.

A radial displacement of the movable part 37 of the second timepiece component 30 relative to the balance spring 25 pulls or pushes the movable body 19 radially relative to the balance spring 25 and thus actuates the levers 14, 26. This changes the stiffness of the flexible element 5, as the displacement of the levers 14, 26, which are rigidly connected to the movable body 18, exerts a greater or lesser force or torque on the flexible element 5, so that the stiffness of the flexible element 5 varies, and consequently the stiffness of the balance spring 25 as a whole also varies. The actuation system 20 thus allows the rate of the regulating member 1 to be regulated.

The stationary part 33 has a substantially elongated shape and comprises a bar 63 intended to be mounted on the first component 22.

As shown in the figures, the second timepiece component 30 is mounted on the first timepiece component 22 so as to be substantially perpendicular to the first timepiece component 22.

The spring part 35 is arranged below the stationary part 33, so that it extends below the level of the first timepiece component 22.

In this case, the spring part 35 comprises two translation stages 51, 52 with flexible blades arranged in series, one after the other. They are defined as being in series because the displacements of each translation stage are at least partly cumulative.

Each translation stage 51, 52 comprises a pair of substantially parallel flexible blades 61, 62 and a rigid section 56, 57 on which the pair of flexible blades 61, 62 is mounted.

The first translation stage 51 is arranged on the stationary part 33 and comprises a first rigid section 56 which is lengthened in order to be associated with a second translation stage 52 arranged head-to-tail with the first translation stage 51, i.e. in the opposite direction. In this way, the second pair of flexible blades 62 is substantially parallel to the first pair of flexible blades 61.

The second rigid section 57 is substantially parallel to the first rigid section 56, but is offset.

This arrangement of translation stages 51, 52 enables the movable part 37 to be displaced in a substantially linear, preferably rectilinear, manner, while maintaining a compact second timepiece component 30.

Two translation stages arranged head-to-tail enable the vertical deviation of the hook 39 generated by each to be mutually compensated for. In this way, the hook 39 remains at substantially the same height while moving.

The movable part 37 extends from the second section 57. The movable part 37 is preferably rigid. In this case, the movable part 37 has the shape of an elbow formed by a first segment 66 arranged perpendicular to the second section 57 and a second segment 67 forming a right angle with the first segment 66.

The hook 39 of the second timepiece component 30 is located at the end of the branch of the second segment 67. At the free end of the first segment 66, a bulge 68 acts as a support for moving the movable part 37.

By pressing more or less hard on the bulge 68, the movable part 37 moves substantially parallel to the stationary part 33, thanks to the deformation of the translation stages 51, 52 of the spring part 35.

In this way, the hook 39 pulls more or less hard on the levers 14, 26, via the movable body 19, to actuate the means for adjusting the stiffness of the flexible element 5.

The direction of displacement of the movable part 39 of the second timepiece component 30 and of the movable body 19 is substantially orthogonal to the direction of the movable body 19, or to the axis O.

Moreover, the movable body 19 is preferably movable in the hook 39, so that it can slide when the movable body 19 performs an angular displacement in the plane of the balance spring 25.

For example, in order to be able to adjust the beat of the regulating member 1, the stud-holder 31 must be able to rotate. Consequently, the balance spring 25 rotates with the stud-holder 31, and the movable body 19 slides in the hook 39.

Thanks to such an actuation system 20, the beat can be regulated without having to modify the position of the second timepiece component 30, in particular with respect to the plate of the movement. The mechanical link between the second timepiece component 30 and the movable body 19 is maintained, regardless of the position of the movable body 19 relative to the second timepiece component 30.

This actuation system 20 thus enables the rate and the beat to be regulated independently of each other, while keeping a constant predetermined position of the second timepiece component in the movement, for example in relation to the plate and to the balance cock 22.

The actuation system 20 further comprises regulating means cooperating with the second timepiece component 30 so as to be able to displace the movable part 37 of the second timepiece component 30.

As shown in FIG. 1, the regulating means comprise a pivoting regulating lever 45 arranged to displace the movable part 37 of the second timepiece component 30. The regulating lever 45 is preferably arranged in a plane substantially perpendicular to the plane of the second timepiece component 30, and is in contact with the bulge 68 of the movable part 37.

The regulating lever 45 has a pivot arm 69 and a support arm 71 connected to a hub 72 of the pivoting regulating lever 45.

The support arm 71 cooperates with the movable part 37 of the second timepiece component 30 to displace it mechanically by contact. The support arm 71 pushes the bulge 68 of the movable part 37 to a greater or lesser extent to move it. The hook 39 thus pulls the movable body 19, and thus the levers 14, 26 of the balance spring 25 to a greater or lesser extent. The regulating lever 45 is configured to pivot in a plane substantially perpendicular to the plane of the second timepiece component 30.

The regulating lever 45 is configured to be mounted on the plate of the movement via the hub 72, which can rotate about a pipe 73, made in one piece with the plate.

Thus, by rotating the regulating lever 45 about the pipe 73, the movable part 37 moves towards or away from the stationary part 33, in a plane parallel to the plane of the plate, through the more or less pronounced deformation of the spring part 35 of the second timepiece component 30.

The regulating means further include a control screw 70 mechanically connected to the pivot arm 69, in order to control the pivoting of the regulating lever 45. The axis of the control screw 70 is arranged in the plane of the regulating lever 45 in the direction of the pivot arm 69.

The control screw can be operated using a tool, for example a screwdriver 24, the end of which is shown in FIG. 1.

Thus, by screwing or unscrewing the control screw 70, the regulating lever 45 and the second timepiece component 30 are actuated in order to move the hook 39 and therefore the movable body 19 of the prestressing means 6.

The restoring force of the spring part 35 of the second timepiece component 30 pushes the regulating lever 45 against the control screw 70. In this way, the pivot arm 69 of the regulating lever 45 is held against the control screw 70.

In the figures, the control screw 70, the regulating lever 45, the movable part 37 of the second timepiece component 30, and the levers 15, 26 are each in a first position, in which the hook 39 pulls lightly on the movable body 19.

In a second position, not shown in the figures, the control screw 70 pushes the pivoting arm 69 of the regulating lever 45, so that the support arm 71 in contact with the bulge 68, in turn pushes the movable part 37 of the second timepiece component 30 towards the stationary part 33 by deformation of the spring part 35. In this way, the hook 39 pulls on the movable body 19, and thus on the levers 14, 26, which perform a centrifugal displacement. When the spring part 35 is in the deformed configuration, the flexible blades of the two translation stages 51, 52 deform in opposite directions.

As shown in the figures, the second timepiece component 30 is mounted on the first timepiece component 22 so as to be substantially perpendicular to the first timepiece component 22.

The assembly 10 further comprises means 40 for assembling the second timepiece component 30, in this case the actuator, on the first timepiece component 22, in this case the plate.

According to the invention, the assembly means 40 comprise means 50 for positioning the second component 30 on the first component 22 in a plane substantially parallel to the plane of the first component 22. The positioning means 50 thus prevent the second component 30 from moving on the first component 22, in the plane substantially parallel to the plane of the first component 22.

In this embodiment, the positioning means 50 comprise at least one first catch 41, preferably two catches 41, 42, arranged on the second component 22, and at least one hole 43, preferably two holes 43, 44, arranged in the first component 22, so that each catch 41, 42 is inserted into a hole 43, 44 to position the second component 30 on the first component 22.

In this case, the two catches 41, 42 are arranged at two opposite ends of the actuator. In particular, they are arranged at the ends of the stationary part 33 of the second component 30, which is intended to be mounted on the first timepiece component 22.

Preferably, at least one catch 41 can be snapped into a hole 43. This catch 41 is deformable, for example, so that it can be inserted into the hole 43. The catch 41 has a protrusion at its end, which locks inside the hole 43.

The catches 41, 42 and the holes 42, 43 are arranged perpendicular to the plane of the plate.

The assembly means 40 further comprise means 60 for bearing on the second component 30 to lock the second component 30 on the first component 22, in a direction substantially orthogonal to the plane of the first component 22.

Thus, the second component 30 is held on the first component 22 to prevent it from moving away from the plate. The second component 30 is thus assembled on the first component 22, and is rigidly connected to the first component 22.

The bearing means 60 comprise an assembly body 46 mounted on the first component 22. The assembly means 40 comprise a screw 47 and the assembly body 46 comprises a passage 48 for assembling the assembly body 46 to the first component 22. The screw 47 is inserted through the passage 48 to screw the assembly body 46 into a hole 18 in the first component 22.

The assembly body 46 comprises a peripheral notch 27 cooperating with a projection 29 extending from the first component 22, in order to prevent the assembly body 46 from rotating about the screw 47.

The assembly body 46 comprises a rigid tab 49 extending to the second component 30 to press on the first component 22.

To this end, the second component 30 comprises a bearing face 64, on which the rigid tab 49 rests to apply a force holding the second component 30 on the first component 22.

The second component 30 comprises an opening 58 allowing the rigid tab 49 to pass at least in part through the second component 30.

Moreover, the opening 58 preferably comprises a vertical wall, against which the rigid tab 49 is held, to prevent the rigid tab 49 from rotating with the assembly body 46.

In this embodiment, the opening 58 is arranged through the resilient part 35 of the second component 30, more precisely between the flexible blades 61 of the first translation stage 51, so that the rigid tab 49 presses on the bar 63 of the stationary part 33. For example, the vertical wall is arranged at the base of a flexible blade 61 of the first translation stage 51.

It goes without saying that the invention is not limited to the embodiments of regulating members described with reference to the figures and alternatives can be considered without leaving the scope of the invention.

1. An assembly of two timepiece components, the assembly comprising:
a first timepiece component (22) and a second timepiece component (30); and
means (40) for assembling the first timepiece component (22) to the second timepiece component (30),
wherein the assembly means (40) comprise means (50) for positioning the second component (30) on the first component (22) in a plane substantially parallel to the first component (22), and means (60) for bearing on the second component (30) to lock the second component (30) on the first component (22).

2. The assembly according to claim 1, wherein the second component (30) extends in a plane substantially perpendicular to the first component (22).

3. The assembly according to claim 1, wherein the positioning means (50) comprise at least one first catch (41), preferably two catches (41, 42), arranged on the second component (30), and at least one hole (43), preferably two holes (43, 44), arranged in the first component (22), so that each catch (41, 42) is inserted into a hole (43, 44) to assemble the two components.

4. The assembly according to claim 3, wherein at least one catch (41) can be snapped into a hole (43).

5. The assembly according to claim 1, wherein the bearing means (60) comprise an assembly body (46) arranged on the first component (22), and the second component comprises a bearing face (64), on which the assembly body (46) bears to lock the second component (30) in position.

6. The assembly according to claim 5, wherein the assembly body (46) comprises a rigid tab (49) to press on the first component (22).

7. The assembly according to claim 6, wherein the second component (30) comprises an opening (58) allowing the rigid tab (49) to pass.

8. The assembly according to claim 5, wherein the assembly means (40) comprise a screw (47) and the assembly body (46) comprises a passage (48) for assembling the assembly body (46) to the first component (22), the first component being provided with a hole (18) for the screw (47).

9. The assembly according to claim 3, wherein the second component (30) comprises a stationary part (33) intended to be mounted on the first component (22), and a movable part (37) capable of moving relative to the first component (22).

10. The assembly according to claim 9, wherein the stationary part (33) comprises the one or more catches (41, 42).

11. The assembly according to claim 7, wherein the opening (58) is arranged between the stationary part (33) and the movable part (37).

12. The assembly according to claim 10, wherein the assembly body (46) bears against the stationary part (33).

13. The assembly according to claim 1, wherein the first timepiece component (22) is a plate extending in a first plane and the second timepiece component (30) is an actuator of an actuation system.

14. A horological movement, comprising the assembly according to claim 1.

15. A timepiece, comprising the horological movement according to claim 14.
